(19) United States
(12) Patent Application Publication
(10) Pub. No.: US 2007/0141281 A1
(43) Pub. Date: Jun. 21, 2007

(54) METHOD OF INSULATING A PIPELINE AND MATERIALS THEREFOR

(75) Inventors: Rajan Eadara, Ann Arbor, MI (US); Arnold Joseff, Bloomfield Hills, MI (US); Reuben Tandoh, Southfield, MI (US); Roy Jacobs, Troy, MI (US); Joribeth Joseff, Houston, TX (US); Jeven Joseff, Troy, MI (US); Gaurav Chalana, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: Petrotech Global, Inc.

(21) Appl. No.: 11/564,866

(22) Filed: Nov. 30, 2006

Related U.S. Application Data
(60) Provisional application No. 60/741,793, filed on Dec. 2, 2005.

(51) Int. Cl. B28B 11/00

(52) U.S. Cl. 428/34.4; 528/25

(57) ABSTRACT

Thermal insulation is provided to a subsea pipeline by disposing a thermally insulating tape on the pipeline. The insulating tape has a layer of a syntactic foam composition disposed between layers of a thermoplastic polymer. The syntactic foam composition may be a curable composition, and this composition may be cured either before or after the tape is applied to the pipeline. Application of the tape may be made prior to the deployment of the pipeline in a subsea location or after the pipeline is disposed. The tape may be configured to include attachment features which aid in retaining the tape on the pipeline. Also disclosed are specific tape compositions for insulating subsea pipelines.

### CROSS-REFERENCE TO RELATED APPLICATIONS

This application claims priority of U.S. Provisional Patent Application Ser. No. 60/741,793 filed Dec. 2, 2005, entitled “Wrappable Pipeline Insulation and Method for its Use,” which is incorporated herein by reference.

### FIELD OF THE INVENTION

This invention relates generally to materials and methods for thermally insulating structures. More specifically, the invention relates to materials and methods for insulating pipelines, particularly subsea pipelines.

### BACKGROUND OF THE INVENTION

Subsea pipelines, which in the context of this disclosure include delivery lines, drilling pipes and the like associated with the production and delivery of petroleum and natural gas, need to be insulated in order to prevent problems resultant from the low temperature environment in which they are disposed. Such problems can include thickening of hydrocarbon materials as well as the formation of solid clathrates and hydrates which can clog pipelines and components and otherwise interfere with the delivery of both liquid petroleum and natural gas.

Prior art methods and materials for insulating such pipelines have been found to be difficult to use. In-field application of insulating materials requires specialized equipment, trained personnel, and necessitates mixing and using precise chemical combinations in what can be a hostile environment. In some instances, pipes are precoated with insulating compositions prior to deployment; however, the presence of insulation then complicates the storage and use of the coated pipeline material. Furthermore, in many situations, insulation needs to be added to pipelines which are already in place, and such installations are typically made under conditions of low temperature, high pressure and poor visibility. The fact that any insulation material must resist low temperatures and high pressures as well as be stable in an ambient environment which can include salt water, significant ultraviolet light exposure, as well as contact with chemicals such as hydrocarbons, acids and alkalis complicates and limits the use of pipeline insulation techniques.

The prior art discloses a number of insulated structures for subsea pipelines wherein layers of insulating material are typically cast onto a pipeline material. Such systems are shown, for example, in U.S. Pat. Nos. 6,397,895 and 6,058,979. Compositions having specifically stated utility for insulating subsea pipelines are disclosed, for example, in U.S. Pat. Nos. 6,746,761; 6,892,817; 6,284,809; 6,706,776; 6,520,261; and 3,622,437.

The prior art generally requires that an insulation composition be disposed upon pipeline segments prior to the time they are deployed in an undersea application. In particular instances, insulation compositions may be applied to previously deployed structures, as for example in connection with repair or replacement operations; however, such after-the-fact applications can be very difficult to carry out and typically require the use of a highly specialized diving crew or complicated and expensive remotely operated robotic equipment.

In view of the need for insulating such subsea structures, and further in view of the general inadequacies of prior art approaches, it will be appreciated that there is a need for materials and methods for insulating subsea structures, which materials and methods are simple to use and do not unduly complicate storage and handling of drill pipe or pipeline stock. As will be explained hereinbelow, the present invention provides for an insulating material which may be applied to drill pipes, pipelines and other such structures either immediately before or well after their installation. The insulating material of the present invention is environmentally stable, simple to use, and provides for a high degree of insulation. These and other advantages of the invention will be apparent from the drawings and discussion presented herein.

### SUMMARY OF THE INVENTION

Disclosed is a method for insulating a pipeline wherein a thermal insulation tape which comprises a first and a second layer of a thermoplastic polymer, with a layer of a syntactic foam composition disposed therebetween, is applied to the pipeline. In particular instances, the syntactic foam composition is a curable composition wherein curing produces a change in a physical property of the polymer. In such instance, curing of the composition may be carried out either before or after the tape is disposed on the pipeline.

A variety of syntactic foam compositions may be employed including, but not limited to, compositions which include a urethane or acrylated urethane, together with an epoxy. In some instances, the syntactic foam may comprise a mixture of polymers which form an interpenetrating network structure. The syntactic foam may include hollow spheres, such as glass and/or ceramic spheres disposed therein.

In some instances, the syntactic foam has a thickness in the range of 1-20 millimeters, and the layers of first and second thermoplastic polymer each have a thickness in the range of 1-10 millimeters. In some instances, at least one of the layers of thermoplastic polymer may have a coupling feature associated therewith to aid in retaining the tape on the pipeline. The tape may be applied to the pipeline either before or after the pipeline is disposed in a body of water, and in some instances, the tape may be adhesively affixed to the pipeline.

Also disclosed is a thermally insulating tape for use in the practice of the method.

### BRIEF DESCRIPTION OF THE DRAWINGS

FIG. 1 is a cross-sectional view of one thermally insulating tape which may be used in the practice of the present invention;

FIG. 2 is a cross-sectional view of another embodiment of thermally insulating tape which incorporates an adhesive layer and which may be used in the practice of the present invention;

FIG. 3 is a perspective view of a portion of a thermally insulating tape which may be used in the practice of the present invention and which includes a molded-in coupling for aiding in the affixation of the tape to a pipeline; and

FIG. 4 is a cross-sectional view of a portion of a pipeline having a thermally insulating tape affixed thereto.

### DETAILED DESCRIPTION OF THE PREFERRED EMBODIMENTS

The present invention comprises a simple to use, stable, insulating tape which can be configured to be wrapped about pipelines and other such structures. As such, the present invention has utility as an insulating material for subsea petroleum delivery pipelines as well as for petroleum pipelines disposed in other extreme temperature environments both on the surface and beneath the surface of the earth.

The insulating tape of the present invention is a multilayered body of material comprised of a layer of a syntactic foam disposed between two layers of a thermoplastic material. As is known in the art, a syntactic foam comprises a matrix material having low density particles disposed therein. The particles decrease the density of the foam composition, while providing rigidity to the material. In some instances, the syntactic foam may include particles of several different sizes, and in many instances these particles are hollow. In the present invention, the syntactic foam comprises a polymeric matrix which has particles of an inorganic material, such as a glass, ceramic, metal or other mineral disposed therein. In some instances, at least some of the particles may be hollow. Also, it should be understood that the matrix itself can be a conventionally foamed polymer.

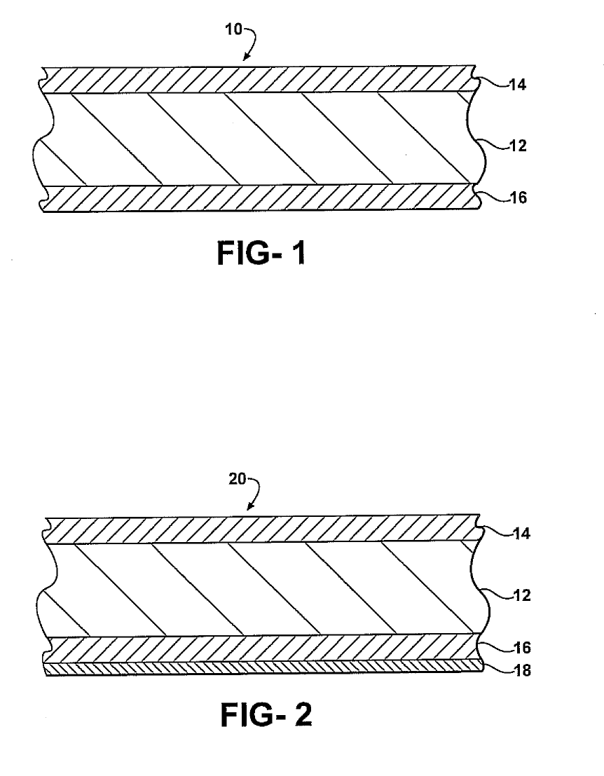

Referring now to FIG. 1, there is shown one embodiment of insulating tape at reference numeral 10. The tape 10 of FIG. 1 includes a body of a syntactic foam polymeric material 12, disposed between a first 14 and a second 16 layer of thermoplastic material. The syntactic foam comprises a polymeric matrix with glass or ceramic spheres therein. In one particular group of embodiments, the matrix is comprised of a mixture of two different polymers which form an interpenetrating network. For example, in a particular embodiment, the polymers comprise a urethane (including substituted urethanes, such as an acrylated urethane) and an epoxy, together with glass microspheres. The foregoing composition can be formulated so as to be curable, wherein curing changes a physical property of the matrix such as its stiffness, flexibility or density; and curing may be implemented either before or after the tape is disposed in a use configuration. In particular applications wherein the structure is exposed to a high pressure environment such as a subsea environment, curing may be initiated by pressure. For example, appropriate curing agents may be disposed in rupturable containers which break under high pressure conditions releasing a cure agent. In other instances, curing may be accomplished prior to use.

The thermoplastic layers 14 and 16 serve to protect the syntactic foam layer and further operate to facilitate handling and use of the insulating tape structure. There are a variety of materials which may be employed as thermoplastic polymers in this invention. Olefin polymers such as polyethylene and polypropylene have utility in the practice of the present invention as do polyester materials such as PET and the like. In some instances where high temperature and/or environmental resistance is required, specialized polymers such as polyimides, polyamides, silicones, styrene butadiene rubber copolymers (SBR), styrene acrylonitrile copolymer (SAN), acrylonitrile butadiene styrene copolymers (ABS), EPDM, polysulfones and the like may be utilized.

The thickness of the layers will depend upon particular applications. However, in one group of embodiments, it has been found that the syntactic foam layer may have a thickness in the range of 1-20 millimeters, while in other instances it may be thicker. The thermoplastic layers may have a thickness in the range of 1-10 millimeters, and particular applications may employ thicker or thinner layers. The thermoplastic layer will/or can be a layer or multilayers of plastics that contain recycled plastics or recycled rubber.

One specific formulation for the insulating, syntactic foam layer comprises, on a weight basis, 30% of an epoxy resin such as the material sold under the designation Npel 128 by the Nan Ya corporation and 15% of polyurethane or acrylated polyurethane; 15% by weight of a polyetheramine material sold under the designation Jeffamine D2000 by the Huntsman corporation; and 15% by weight of a polyetheramine product sold under the name Jeffamine D230 by the Huntsman corporation. This composition further includes 20% by weight of glass bubbles, and one particular group of such glass bubbles is the product sold by the 3M corporation under the designation Scotchlite glass bubble S60HS, and 5% of carbon fibers. This material has a size of approximately 10-120 microns. Other formulations will be readily apparent to those of skill in the art.

The insulating tape of the present invention may be prepared by a variety of processes. One particular process comprises a coextrusion process wherein the three layers are simultaneously extruded to form the structure of FIG. 1. In other instances, sequential extrusions as well as other coating processes may be employed.

Referring now to FIG. 2, there is shown another embodiment of insulating tape 20. This embodiment 20 includes a syntactic foam layer 12 and thermoplastic layers 14 and 16 as previously described. It further includes a layer of an adhesive material 18 disposed on a second face of one of the thermoplastic layers 16. This adhesive 18 facilitates affixation of the tape to a pipeline or other structure. The adhesive 18 may comprise a contact or pressure sensitive adhesive, although other adhesives including curable adhesives may likewise be employed.

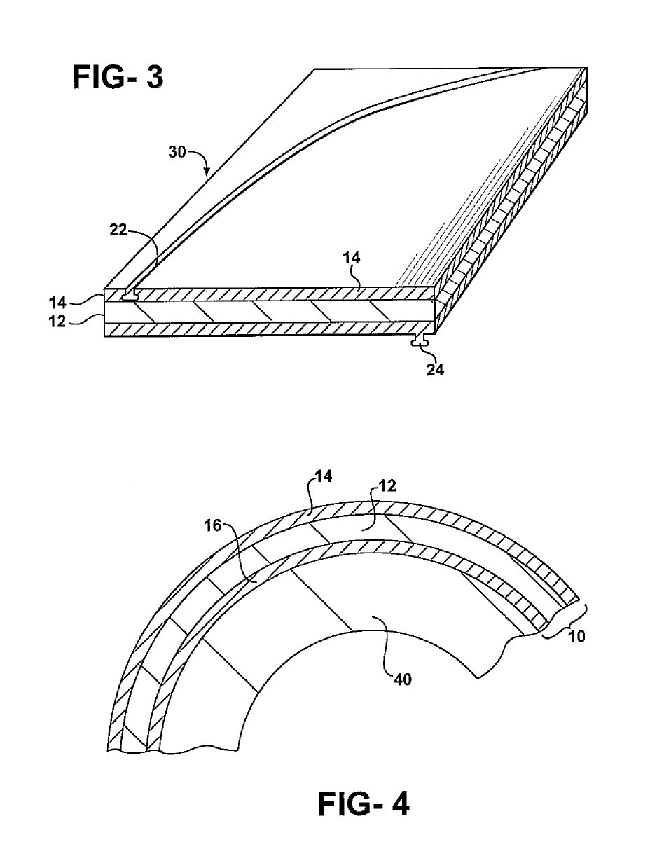

Referring now to FIG. 3, there is shown a perspective view of yet another embodiment of insulating tape 30 structured in accord with the principles of the present invention. This tape 30 includes a syntactic foam layer 12 and thermoplastic layers 14 and 16 as previously described. However, in the FIG. 3 embodiment, a first coupling feature 22 is defined in the first thermoplastic layer 14, and a second, corresponding, coupling feature 24 is defined in the second thermoplastic layer 16. As shown in FIG. 3, the first coupling feature 22 comprises a groove extending along one edge of the tape 30, while the second feature 24 comprises a corresponding ridge 24. The ridge 24 is configured so that it will snap into and be retained by the groove 22. When the tape 30 of FIG. 3 is wrapped around a structure such as a pipeline, the coupling features 22 and 24 cooperate to lock the edges of the tape together. As shown, the groove is angled along the surface of the tape 30, so that it may be wrapped in a spiral orientation around the pipeline. Other configurations may be implemented. The adhesive layer of FIG. 2, as well as the coupling features of FIG. 3, may be used either singly or in combination. Other locking features such as hook-and-loop fasteners, snaps, toggles and the like may also be utilized.

Referring now to FIG. 4, there is shown a partial cross section of a pipe 40 having an insulating tape 10 generally similar to that of FIG. 1 wrapped thereabout. The tape of the present invention may be wrapped about the pipe 40 as the pipe is being deployed into a drilling system or as it is being laid in place. Alternatively, the pipe may be prewrapped with the tape. In yet other instances, the tape may be applied after the pipeline is deployed as for example by a robotic winding device which travels the length of the pipe wrapping the tape thereabout. In some instances, tape may be utilized to repair a previously insulated pipe in situ. Such pipe may have been insulated with the tape of the present invention or with prior art insulating structures. The flexibility of the tape of the present invention greatly facilitates such applications.

As noted above, the formulation of the present invention may be a curable formulation, and curing may be initiated at the time the material is being deployed, or at some time thereafter. Curing conditions can be selected so that the composition foams when cured thereby decreasing its density and increasing its insulation value. Such foaming also has the advantage of increasing the volume of the tape thereby causing it to swell and tighten around the object being insulated. In addition, curing can increase the hardness of the tape and create compressive forces strengthening the bond of the tape to the pipeline as well as increasing the strength and damage resistance of the pipeline.

Structures of the present invention are very durable and resist mechanical impacts as well as hydrocarbons, acids, alkalis and other chemical species. Furthermore, the structures of the present invention are very stable to adverse atmospheric conditions such as low temperatures, high temperatures, ultraviolet light, salt water and the like. The table below lists some representative properties of particular insulating tapes:

| Property | Value | | Method |
|---|---|---|---|
| Compressive Strength | >5000 | psi | ASTM D695 |
| Thermal Conductivity | <0.4 | W/M-° K | ASTM C518 |
| Corrosion Resistance | >1000 Hours Sea | | |
| | Water Soak No Effect | | |
| Water Absorption @ 1000 psi | <1.0% | | BS903 |
| Tensile Strength | >5000 | psi | ASTM D638 |
| Modulus | >500,000 | psi | ASTM D638 |

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

1. A method for insulating a pipeline, said method comprising the steps of:
providing a thermal insulation tape, said tape comprising:
a first and a second layer of a thermoplastic polymer, and a layer of a syntactic foam composition disposed therebetween; and
disposing said tape on said pipeline.

2. The method of claim 1, wherein said syntactic foam composition is a curable composition wherein said curing produces a change in a physical property of said polymer.

3. The method of claim 2, including the further step of curing said curable composition prior to disposing said tape on said pipeline.

4. The method of claim 2, including the further step of curing said composition after disposing said tape on said pipeline.

5. The method of claim 1, wherein said syntactic foam composition includes a polymeric material comprising a urethane or an acrylated urethane polymer together with an epoxy polymer.

6. The method of claim 1, wherein said syntactic foam composition comprises a mixture of polymers which form an interpenetrating network structure.

7. The method of claim 1, wherein said syntactic foam composition includes a plurality of hollow spheres therein.

8. The method of claim 7, wherein said hollow spheres are glass spheres and/or ceramic spheres.

9. The method of claim 1, wherein the layer of syntactic foam has a thickness in the range of 1-20 millimeters.

10. The method of claim 1, wherein said first and second layers of thermoplastic polymer each have a thickness in the range of 1-10 millimeters.

11. The method of claim 1, wherein at least one of said first and second layers of thermoplastic polymer have a coupling feature associated therewith.

12. The method of claim 1, wherein at least one of said first and second layers of thermoplastic polymer comprises a material selected from the group consisting of: olefin polymers, polyimide, polyamide, silicone, SBR, EPDM, SAN, ABS, polysulfone, polyesters, and combinations thereof.

13. The method of claim 1, wherein said pipeline is disposed in a body of water and said tape is applied thereto prior to said pipeline being disposed in said body of water.

14. The method of claim 1, wherein said pipeline is disposed in a body of water and said tape is applied to said pipeline after said pipeline has been disposed in said body of water.

15. The method of claim 1, wherein the step of disposing said tape on said pipeline comprises adhesively affixing said tape to said pipeline.

16. A thermally insulating tape comprising:
a first and a second layer of a thermoplastic polymer; and
a layer of a syntactic foam composition disposed therebetween.

17. The tape of claim 16, wherein said syntactic foam composition comprises a polymeric material which forms an interpenetrating network.

18. The insulating tape of claim 17, wherein said interpenetrating network is formed from a mixture which includes a first component which is a urethane polymer or an acrylated urethane polymer, and a second component which is an epoxy polymer.

19. The insulating tape of claim 16, wherein said syntactic foam composition is a curable composition, which upon curing manifests a change in at least one physical property selected from the group consisting of stiffness, hardness, porosity, and density.
